(19) United States
(12) Patent Application Publication
(10) Pub. No.: US 2025/0248887 A1
(43) Pub. Date: Aug. 7, 2025

(54) COMBINED VACUUM AND VIBRATORY GENITAL THERAPY APPARATUS WITH INTEGRATED PRESSURE-ACTUATED VIBRATION GENERATOR

(71) Applicants: Olympia Manufacturing Company Limited, Hong Kong (CN); California Exotic Novelties LLC, Ontario, CA (US)

(72) Inventor: Yau Chuen David Lam, Hong Kong (CN)

(21) Appl. No.: 18/429,876

(22) Filed: Feb. 1, 2024

(51) Int. Cl. A61H 19/00; A61H 23/02

(52) U.S. Cl. CPC A61H 19/32; A61H 23/0254; A61H 2201/0107; A61H 2201/0153; A61H 2201/0165; A61H 2201/1215; A61H 2201/1238; A61H 2201/1409; A61H 2201/165; A61H 2201/5056; A61H 2205/087

(57) ABSTRACT

A combined vacuum and vibratory genital therapy apparatus includes a vacuum vessel that is sized and configured to accommodate a human genital therein. The vacuum vessel has an opening to receive the human genital while forming an air seal that allows air pressure to be reduced within the vacuum vessel. A vacuum pump is operatively connected to the vacuum vessel and operable to remove air from the vacuum vessel in order to reduce the air pressure therein. A pressure-actuated vibrator unit is arranged to deliver vibratory stimulation to the human genital when disposed within the vacuum vessel in response to the air pressure within the vacuum vessel being reduced to a predetermined air pressure level representing a vibrator unit activation threshold pressure.

### BACKGROUND

### 1. Field

The present invention relates to vacuum therapy equipment for stimulating blood flow within human genitalia.

### 2. Description of the Prior Art

By way of background, vacuum genital therapy devices have been used to stimulate blood flow in both male and female genitalia. When constructed for male genitalia, such devices conventionally include an elongated vacuum vessel whose interior forms a vacuum chamber that receives a user's penis through an opening at the vessel's base end. Vacuum tubing typically connects to the other end of the vacuum vessel and communicates with a pump device. With the base end of the vacuum vessel seated firmly against the pubic area surrounding the base of the penis, the user activates the pump to create a partial vacuum within the vacuum chamber. The partial vacuum increases blood flow within the penis, thereby producing or enhancing an erection. Analogously-constructed vacuum therapy devices have been proposed for clitoral and/or vaginal stimulation in females, with the vacuum vessel being appropriated sized and configured to accommodate the clitoris, the vaginal opening and surrounding labia, or the entire vulva.

Some vacuum genital therapy devices incorporate a battery-powered vibration motor in order to deliver vibratory massage in combination with vacuum therapy. The vibration motor is operated by way of a manually-operated electrical switch situated outside the vacuum chamber, where it is accessible to the user.

It is to improvements in vacuum genital therapy devices, and particularly those having vibration delivery capability, that the present disclosure is directed.

### SUMMARY

A combined vacuum and vibratory genital therapy apparatus includes a vacuum vessel that is sized and configured to accommodate a human genital therein. The vacuum vessel has an opening to receive the human genital while forming an air seal that allows air pressure to be reduced within the vacuum vessel. A vacuum pump is operatively connected to the vacuum vessel and operable to remove air from the vacuum vessel in order to reduce the air pressure therein. A pressure-actuated vibrator unit is arranged to deliver vibratory stimulation to the human genital when disposed within the vacuum vessel in response to the air pressure within the vacuum vessel being reduced to a predetermined air pressure level representing a vibrator unit activation threshold pressure.

### BRIEF DESCRIPTION OF THE DRAWINGS

The foregoing and other features and advantages will be apparent from the following more particular description of example embodiments, as illustrated in the accompanying Drawings.

FIG. 1 is perspective view showing a combined vacuum and vibratory genital therapy apparatus constructed in accordance with an embodiment of the present disclosure.

FIG. 2 is a perspective view showing a vacuum vessel and interconnected hand-operable vacuum pump of the FIG. 1 genital therapy apparatus.

FIG. 3 is a side elevation view showing a vibration motor unit of the FIG. 1 genital therapy apparatus.

FIG. 4 is a perspective view showing the vibration motor unit of FIG. 3 mounted to an internal sleeve of the FIG. 1 genital therapy apparatus to form an internal sleeve and vibration motor unit assembly.

FIG. 5 is an exploded side elevation view showing an example arrangement for assembling the internal sleeve and vibration motor unit assembly of FIG. 4.

FIG. 6 is an exploded perspective view showing the FIG. 1 genital therapy apparatus with the internal sleeve and vibration motor unit assembly removed from the vacuum vessel.

FIG. 7 is an exploded perspective view showing the genital therapy apparatus components of FIG. 6 after the internal sleeve and vibration motor unit assembly have been inserted into the vacuum vessel and affixed thereto.

FIG. 8 is a cross-sectional centerline perspective view of the vibration motor unit of FIG. 3 showing example components thereof.

### DETAILED DESCRIPTION OF EXAMPLE EMBODIMENTS

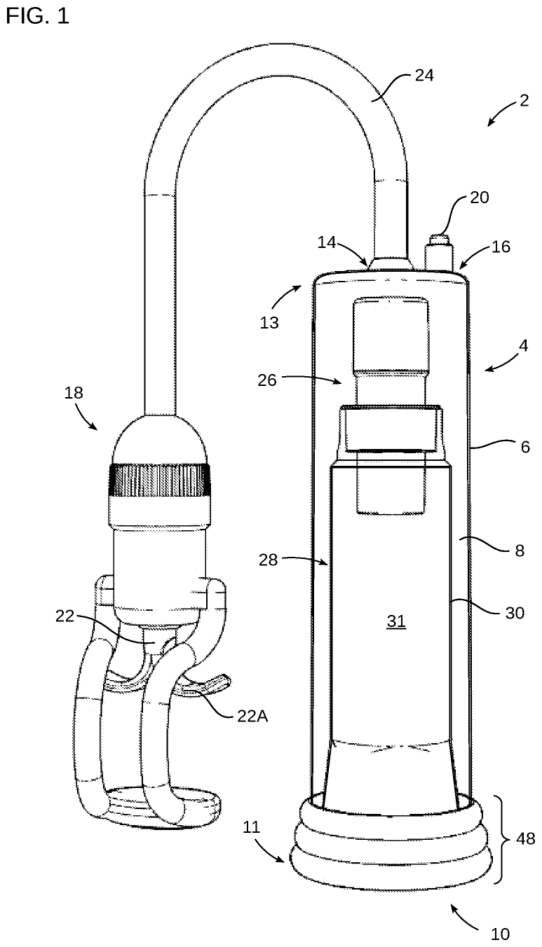

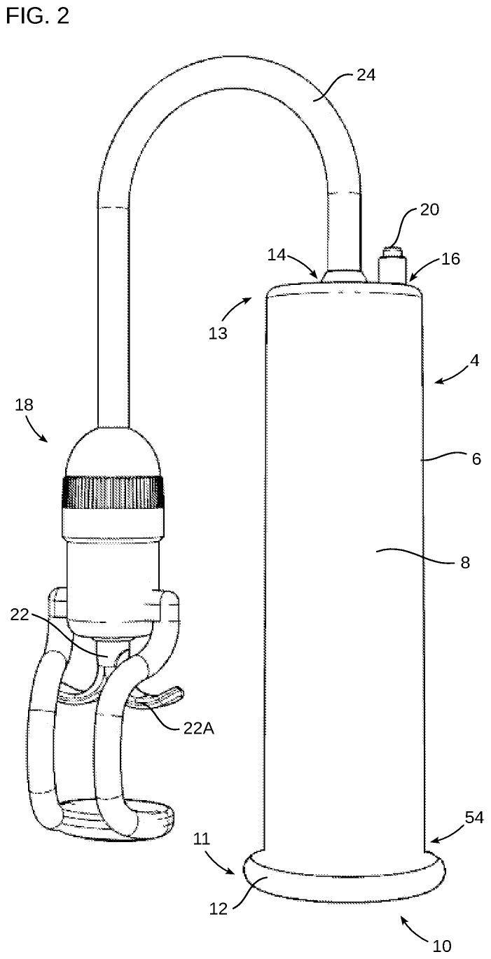

Turning now to the figures, wherein like reference numerals represent like elements in all of the several views, FIGS. 1 and 2 depict a combined vacuum/vibratory genital therapy apparatus 2 that may be constructed in accordance with one possible embodiment of the subject matter disclosed herein. The genital therapy apparatus 2 may include a vacuum vessel 4 that is sized and configured to accommodate a human genital therein, and particularly a human male genital, namely a penis. In this configuration, the vacuum vessel 4 may be formed as an elongated tubular body 6 of (e.g., of cylindrical shape) having a hollow interior chamber 8 that receives the penis. Although not shown, an alternative vacuum vessel according to other embodiments could be sized and configured to accommodate female genitalia, namely a clitoris, a vaginal opening and surrounding labia, or an entire vulva, if it is desired to deliver vacuum therapy to these organs. For example, a vacuum vessel designed for clitoral use could have a tubular body that is shorter and narrower than the tubular body 6 of FIGS. 1-2, so as to define a hollow interior chamber that is suited for receiving a female clitoris. A vacuum vessel designed for vaginal/labial/vulva use could have a body formed as a shallow cup of triangular or oval shape so as to define a hollow interior chamber suited for receiving a female vaginal opening, or a vaginal opening together with the surrounding labia, or a vaginal opening together with the surrounding labia and the adjacent clitoris.

Regardless whether the genital therapy apparatus 2 is designed for male or female use, its vacuum vessel may be formed from any suitable material that is capable of maintaining a negative air pressure differential within its hollow interior chamber relative to the ambient environment outside the vacuum vessel (i.e., below-ambient air pressure), thereby allowing a partial vacuum to be formed within the vacuum vessel. Examples of suitable vacuum vessel materials include rigid plastic and glass that can withstand negative pressure differentials as high as 250 Torr below ambient pressure (ambient pressure being approximately 740 Torr at sea level). In an embodiment, the material used for the vacuum vessel 4 of FIGS. 1-2 (and other vacuum vessel embodiments) may be transparent (or translucent) so that the user may observe the effects of the below-ambient pressure on their genitalia. In that case, incremental hash markings and a graduated scale may be printed and/or formed on the vacuum vessel 4 so that the user can measure the change in genitalia size (e.g., penis length) caused by increases and decreases in the negative pressure differential.

As shown in FIG. 2, the vacuum vessel 4 may include an opening 10 at a lower first end 11 thereof that is sized and configured to receive a genital (e.g. a penis) while facilitating the formation of an air seal (e.g., with the base of the penis or an adjacent body portion that surrounds the penis), thus allowing the below-ambient air pressure within the vacuum vessel to be suitably maintained. For example, the opening 10 may be a circular opening defined by a bulbous rim 12 formed on the lower end 11 of the vacuum vessel 4. Other opening configurations may also be used.

An upper second end 13 of the vacuum vessel 4 may be substantially closed with the exception of one or more openings for removing and/or introducing air within the vacuum vessel. For example, a vacuum port 14 may be provided for drawing air out of the vacuum vessel during vacuum formation, and a vent port 16 may be provided for venting the vacuum and reintroducing air into the vacuum vessel 4 to restore ambient pressure.

A vacuum pump 18 may be operatively connected to the vacuum port 14 and a finger-operated pressure relieve valve mechanism 20 may be operatively connected to the vent port 16. The vacuum pump 18 is operable to remove air from the vacuum vessel 4 in order to reduce the air pressure therein. It may be implemented in various ways. For example, in the illustrated embodiment, the vacuum pump 18 is shown as a hand-operable pump unit having a plunger mechanism 22 with a finger-actuated trigger 22A that a user May pull to draw air from the vacuum vessel 4 via the vacuum port 14. Such an embodiment of the vacuum pump 18 may be operatively connected to the vacuum port 14 by way of a flexible air hose 24. In other embodiments (not shown), the vacuum pump 18 could be configured as an automated pump unit having a motorized pumping mechanism. Such an embodiment of the vacuum pump 18 may also be operatively connected to the vacuum port 14 by way of the flexible air hose 24. Alternatively, an automated embodiment of the vacuum pump 18 could be fixedly mounted to vacuum vessel 4 itself, such as on the upper end 13 where the vacuum port 14 is formed, with the pump overlying the vacuum port and being in fluid communication therewith.

As shown in FIG. 1, a pressure-actuated vibrator unit 26 may be arranged to deliver vibratory stimulation to a human genital disposed within the vacuum vessel 4. The vibrator unit 26 is operable to switch from a power-off standby mode to a power-on activation mode in response to the air pressure within the vacuum vessel being reduced to a predetermined below-ambient pressure level, representing a vibrator unit activation threshold pressure. The vibrator unit 26 will remain in the power-on activation mode so long as the pressure within the vacuum vessel 4 remains at or below the activation threshold pressure. The vibrator unit 26 is operable to switch back to the power-off standby mode in response to the air pressure within the vacuum vessel increasing above the activation threshold pressure.

The vibrator unit 26 may be designed so that its activation threshold pressure falls anywhere between the ambient pressure that exists prior to the vacuum pump 18 being operated to a maximum below-ambient pressure level that a user would normally apply to their genitalia during use of the genital therapy apparatus 2. This pressure level may be referred to as a user-preferred below-ambient pressure maximum. By way of example only, the vibrator unit 26 could be designed so that its activation threshold pressure falls within a range of 25%-75% of the user-preferred below-ambient pressure maximum. Activation threshold pressure values above or below this range may also be used. However, it is worth noting that the closer the activation threshold pressure is to ambient pressure, the sooner the vibrator unit 26 will begin generating vibrations as air is pumped out of the vacuum vessel 4, and the later the vibrator unit will stop generating vibrations as air is vented out of the vacuum vessel. It will thus be appreciated that the time duration of the vibration therapy delivered by the vibrator unit 26 will be dictated, at least in part, by the design selection of the vibrator's activation threshold pressure.

The vibrator unit 26 may be disposed within the vacuum vessel 4 in any suitable manner. By way of example, FIG. 1 depicts an arrangement wherein the vibrator unit 26 is mounted to an insert 28 that is removably disposed within the vacuum vessel 4. The insert 28 may be implemented as a flexible internal suction sleeve 30 that extends into the vacuum vessel from the opening 10 at the lower end 11 thereof, and terminates distally therefrom at a location that is more proximate to the vacuum vessel's upper end 13. The sleeve 30 includes a main genital-receiving chamber 31 that is sized and configured to receive the human genital to be inserted into the vacuum vessel 4, such as an erect, semi-erect or flaccid penis. The sleeve 30 may be formed from soft silicone rubber or the like whose interior cavity is expandable to accommodate increases in genital size as the air pressure within the vacuum vessel 4 falls below ambient pressure. In the illustrated embodiment wherein the genital therapy apparatus 2 is designed as a penis pump, the sleeve may be configured as a generally tubular member of sufficient length to accommodate an erect human male penis. Although not shown, the interior wall of the sleeve 30 may be ribbed, textured, or otherwise configured to impart a pleasurable touch sensation to the penis during use of the genital therapy apparatus 2.

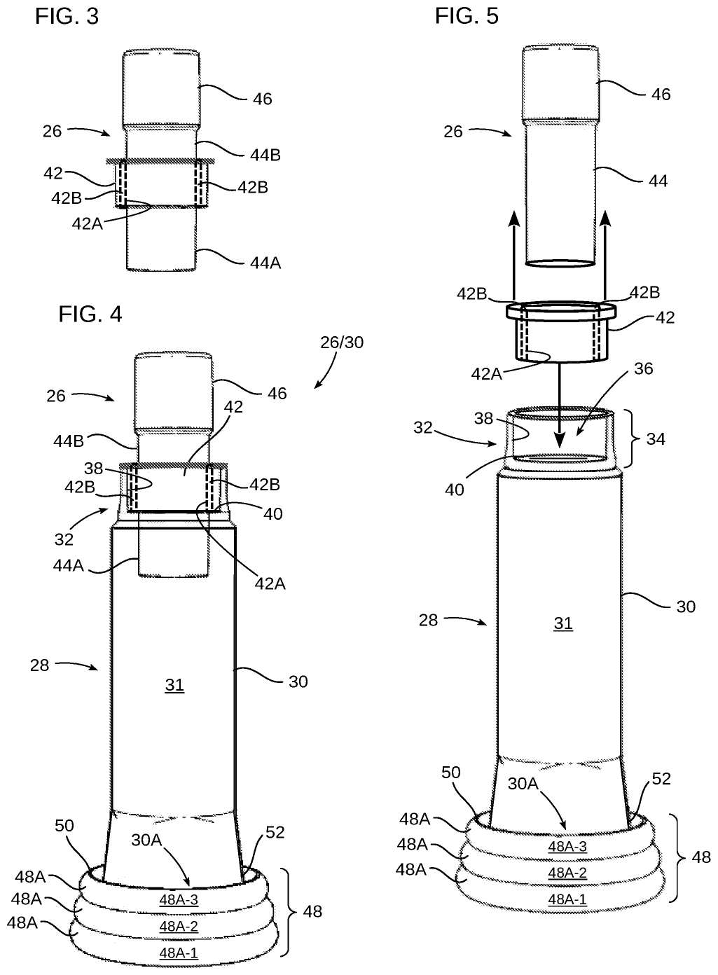

With additional reference now to FIGS. 3-5, the vibrator unit 26 may be attached to an upper first end portion 32 of the sleeve 30 so as to form an internal sleeve and vibration motor unit assembly 26/30. The upper end portion 32 of the sleeve 30 is disposed at the previously-mentioned terminal end of the sleeve that is distal from the vacuum vessel's lower opening 10 and more proximate to the vacuum vessel's upper end 13. As best shown in FIG. 5, the first end portion 32 of the sleeve 30 may be formed as a tubular neck 34 that defines a bore opening 36 through which the vibrator unit 26 may be inserted. The bore opening 36 has an inner wall 38 that extends from the top of the bore opening 36 to (and below) a lower annular shoulder 40 (shown additionally in FIG. 4). The vibrator unit 26 may be secured to the neck 34 by way of a collar 42 having an interior bore 42A that surrounds a lower housing section 44 of the vibrator unit and seats within the bore opening 36 of the sleeve 30.

As shown in FIG. 4, when the collar 42 is thus seated, a bottom portion 44A of the vibrator unit's lower housing section 44, which protrudes below the collar, may extend below the lower annular shoulder 40 of the bore opening 36 and into the genital-receiving chamber 31 of the sleeve 30. As also shown in FIG. 4, an upper portion 44B of the vibrator unit's lower housing section 44, together with an upper housing section 46 of the vibrator unit 26, may extend above the collar 42.

In order to provide pressure equalization between the interior of the sleeve 30 and the greater interior of the sleeve 30, the collar 42 may be formed with one or more vent channels 42B (two are shown) that extend longitudinally along the sides of the collar's interior bore 42A and define radial grooves in the bore wall. The channels 42B allow air to freely flow around the outside of the vibrator unit 26, and specifically its lower housing section 44, between the interior of the sleeve 30 and the greater interior of the vacuum vessel 4. In this way, any reduction in pressure generated within the vacuum vessel 4 when the vacuum pump 18 is operated will result in a corresponding pressure reduction within the sleeve 30, which will be imparted to the user's genitalia when resident therein.

In the illustrated embodiment, the collar 42 is permanently mounted to the inside wall 38 of the sleeve bore opening 36 by way of adhesive bonding or the like to form a collar/sleeve assembly 42/30. The vibrator unit's lower housing section 44 is itself removably attached to the collar 42 using a sliding press-fit interconnection, such that the lower housing section 44 can be separated from the collar/sleeve assembly 42/30 when needed. This arrangement allows a user to readily detach the vibrator unit 26 from the sleeve 30 without undue effort when such component separation is desired. For example, the user may detach the vibrator unit 26 from the sleeve 30 in the event that either component needs to be replaced or serviced. Specifically, the user may wish to wash the sleeve 30, change a battery in the vibrator unit 26, or repair or replace either component.

It will be appreciated that other embodiments may be implemented in which the vibrator unit's lower housing section 44 and the collar 42 are permanently attached together, or even integrally formed as a single component. In that case, the collar may be removably attached to the inside wall 38 of the sleeve bore opening 36. For example, the collar 36 may be secured to the bore opening 35 using a sliding press-fit interconnection wherein the bore opening 35, which is made from the flexible resilient material of the sleeve, is stretched to allow introduction of the collar 42 therein, and thereafter released to resiliently contract onto the collar and grip it to maintain a suitable vacuum seal between the vibrator unit 26 and the sleeve 30 during normal use of the genital therapy apparatus 2.

As shown in FIGS. 4 and 5, a foldable lower end portion 30A of the sleeve 30 may be flipped inside out to form a cuff 48 whose inside surface 50 surrounds a lower outside portion 52 of the sleeve 30, in spaced relationship therewith. As additionally shown in FIG. 1, the cuff 48 is configured to wrap around the lower end 11 of the vacuum vessel 4 when the sleeve 30 is installed therein. If desired, the cuff 48 may be formed with a series of hoop-shaped gripping rings 48A, such as the three gripping rings 48A-1, 48A-2 and 48A-3 shown in FIGS. 4 and 5. The gripping rings 48A help the sleeve 30 maintain its grip on the vacuum vessel 4. The gripping rings 48A also assist the user in removing the sleeve 30 for cleaning or replacement, or for servicing, repairing or replacing the vibrator unit 26.

A lowermost gripping ring 48A-1 of the cuff 48 is arranged to engulf the bulbous rim 12 of the vacuum vessel (see FIG. 2) and surround the vacuum vessel's lower opening 10. It will be appreciated that the lowermost ring 48A-1, which is soft and resilient, thereby facilitates the formation of a suitable air seal between the user and the vacuum vessel 4. The two upper rings 48A-2 and 48-3 extend upwardly from the lowermost ring 48A-1 to cover a lower end portion of the vacuum vessel 4 in surrounding engagement with an outside surface thereof in order to secure the flexible sleeve to the vacuum vessel. This lower end portion of the vacuum vessel 4 is the region depicted by reference number 54 in FIG. 2.

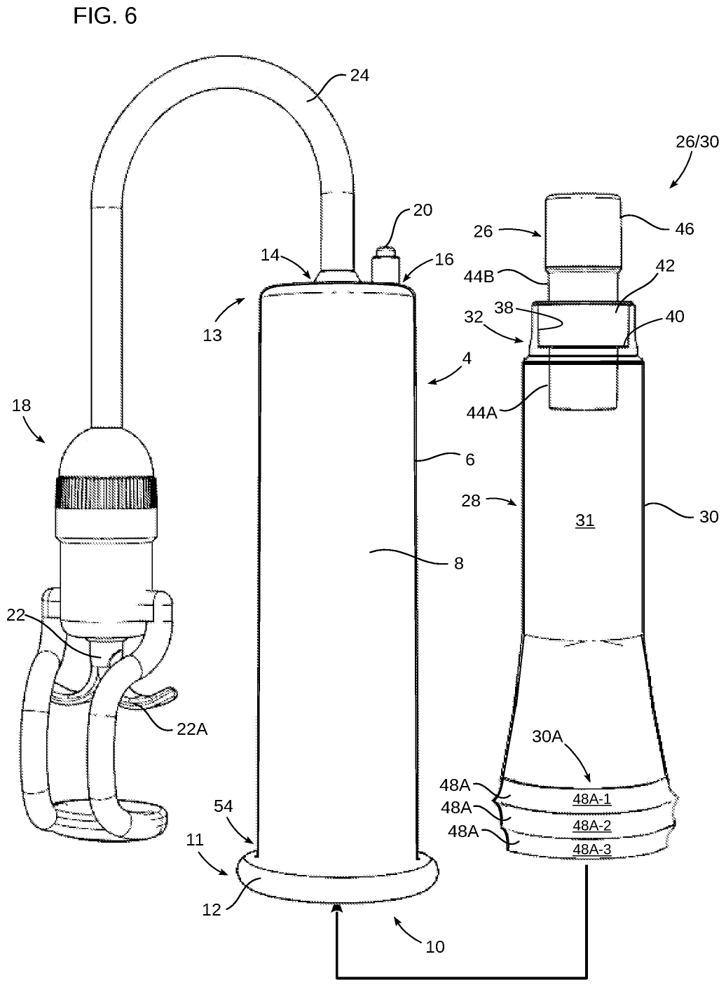

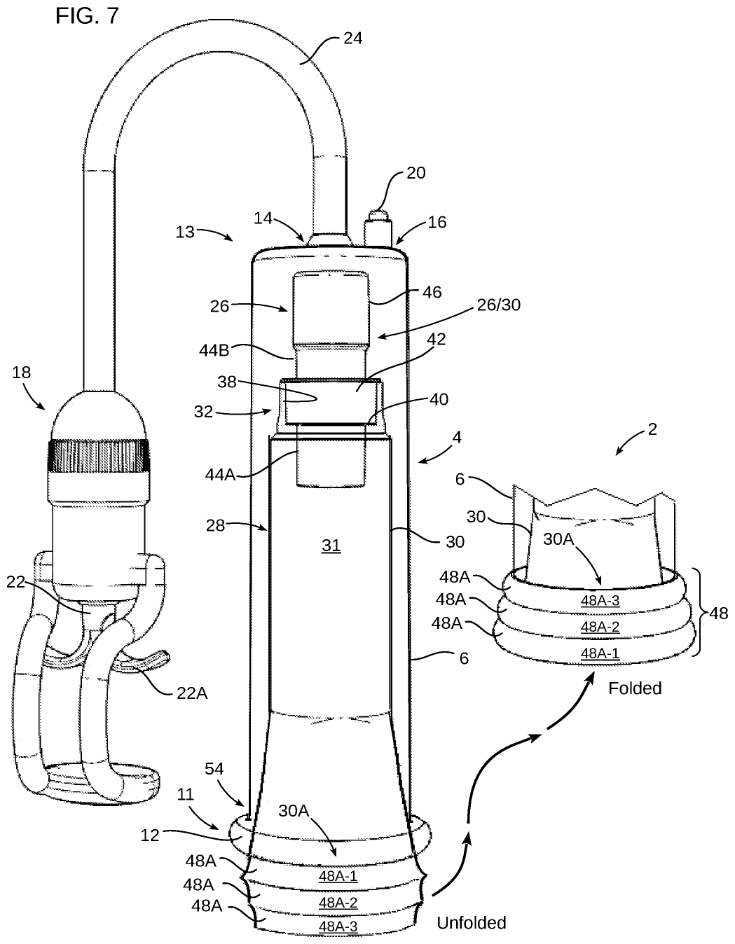

An example technique for removably mounting the sleeve 30 (with the vibrator unit 26 attached) to the vacuum vessel 4 will now be described with reference to FIGS. 6-7. FIG. 6 depicts the internal sleeve and vibration motor unit assembly 26/30 prior to these components being installed within the vacuum vessel 4. As can be seen, the foldable lower end portion 30A of the sleeve 30 has not yet been folded into the cuff 48, such that the gripping rings 48A are inside out. In FIG. 7, the internal sleeve and vibration motor unit assembly 26/30 has been inserted into the vacuum vessel 4 and advanced to its operational position therein. At this point, the foldable lower end portion 30A of the sleeve 30 may be flipped inside out from the unfolded state to the folded state that forms the cuff 48. The genital therapy apparatus 2 is now in an operational condition and ready for use.

The internal sleeve and vibration motor unit assembly 26/30 may be removed from the vacuum vessel 4 using a reverse operation. The cuff 48 of the sleeve 30 may be peeled away from the vacuum vessel's lower end portion 54 and off of the bulbous rim 12 at the opening 10 of the vacuum vessel. The cuff 48 may then be unformed by flipping the foldable lower end portion 30A of the sleeve 30 outside in. The sleeve 30 may then be pulled out of the vacuum vessel 4, carrying the vibrator unit 26 with it.

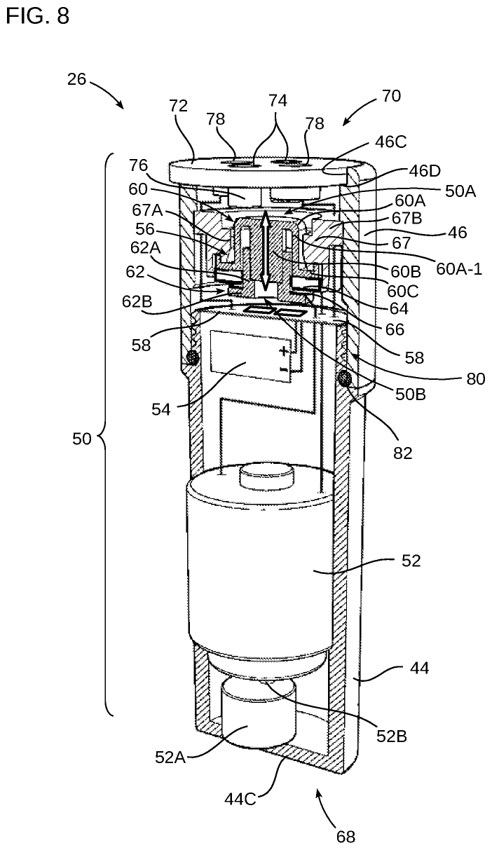

Turning now to FIG. 8, an example construction of the vibrator unit 26 will now be described. In this embodiment, the vibrator unit 26 includes the previously mentioned lower housing section 44 and upper housing section 46, which may be formed as discrete components that are interconnected together (see below) form a vibrator unit main housing 50. Disposed within the main housing 50 are an electric vibration motor 52, an electrical power source 54, a pressure-actuated electrical switch 56, and a control board 58. The arrangement of these components within the main housing may be such that, during use of the genital therapy apparatus 2, the vibration motor 52 will be disposed in close proximity to the user's genitalia in order to deliver vibrational therapy thereto, and the pressure-actuated electrical switch 56 will be disposed in close proximity to the vacuum port 14 and the vent port 16 of the vacuum vessel 4 in order to quickly react to pressure variations resulting from air flow through these ports.

The vibration motor 52 may include the usual eccentric mass 52A mounted to a rotating motor shaft 52B. Other types of vibration motor may also be used. The electrical power source 54 may be provided by a battery or other self-contained energy storage device, which may be of the rechargeable type to enable prolonged use of the vibrator unit 26 without having to replace the power source.

The pressure-actuated switch 56 is operable to electrically connect the electrical power source 54 to the vibration motor 52 in response to the air pressure within the vacuum vessel 4 being at or below the previously described vibrator unit activation threshold pressure, and to electrically disconnect the electrical power source from the electric motor in response to the air pressure within the vacuum vessel being above the activation threshold pressure.

The pressure-actuated switch 56 may implemented using any of a variety of commercially available pressure-sensitive switching devices. In the illustrated embodiment, which represents only one of many different design possibilities, the pressure-actuated switch 56 includes an upper actuator member 60 operatively coupled to a lower throw member 62. By way of example only, the actuator member 60 may be constituted as a flexible elastomeric component formed (e.g., by injection molding) from silicone rubber or the like. The actuator member 60 includes a central bell-shaped dome element 60A operable to actuate up and down in response to changes in air pressure, a central stem 60B extending downwardly from the top of the dome element to couple to the throw member 62, and a lower peripheral base 60C to which a generally disk-shaped stationary electrical contact 64 may be mounted (with other mounting locations also being possible). The throw member 62 may be formed as a rigid structure that includes a central upwardly extending stem 62A that couples to the central stem 60B of the actuator member 60, and a peripheral base 62B to which a generally disk-shaped movable electrical contact 66 may be mounted (with other mounting locations also being possible).

The lower peripheral base 60C of the actuator member 60 is affixed to a rigid switch carrier 67. The switch carrier 67 may be configured as a flanged bushing having an interior bore 67A that encircles the sides of a thin outer dome wall portion 60A-1 of the actuator member's central dome element 60A, in spaced relationship therewith. An upper ring flange portion 67B of the switch carrier 67 is rigidly mounted to an interior sidewall of the upper housing section 46. The mounting connections between the actuator member's lower peripheral base 60C and the switch carrier 67, and between the switch carrier and the interior sidewall of the upper housing section 46, are both airtight. As such, the actuator member 60 and the switch carrier 67 act as a pressure barrier that divides the vibrator unit's main housing 50 into an upper interior compartment 50A and a lower interior compartment 50B. As described in more detail below, the upper interior compartment 50A vents to the greater interior of the vacuum vessel 4, such that the air pressure therein varies dynamically according to the air pressure in vacuum vessel. The air pressure in the lower interior compartment 50B remains substantially constant (e.g., at or near ambient pressure) during use of the genital therapy apparatus 2.

The actuator member 60 and the throw member 62 are configured to maintain a default open circuit condition in the absence of below-ambient air pressure being present in the main housing's upper interior compartment 50A. In this open circuit condition, the 1638-39 electrical contacts 64 and 66 are spaced from each other by an air gap so that no electrical current can flow from the electrical power source 54 to the vibration motor 52. When air pressure in the upper interior compartment 50A drops below ambient pressure, the thin outer dome wall portion 60A-1 of the dome element 60A that carries and surrounds the central stem 60B elongates and bulges upwardly. This elongation and bulging causes the central stem 60B to lift upwardly, carrying the throw member 62 with it. The movable electrical contact 66 mounted to the throw member 62 is thereby pulled upwardly until it touches the stationary electrical contact 64 at a point when the activation threshold pressure of the vibrator unit 26 is reached. The pressure-actuated switch 56 will thereby assume a closed circuit condition and electrical current will flow from the electrical power source 54 to the vibration motor 52. When the air pressure in the upper interior compartment 50A rises above the activation threshold pressure of the vibrator unit 26, (e.g., due to the user venting the vacuum vessel 4 using the finger-operated pressure relief valve mechanism 20), the elastomeric memory of the dome element 60A, and particularly its thin outer dome wall portion 60A-1, will bias the dome element back toward its initial configuration, thereby causing the central stem 60B to push down the throw member 62 and separate the electrical contacts 64 and 66. The vertical double-headed arrow shown in FIG. 8 illustrates the up and down movement of the actuator member 60 as it lifts and lowers the throw member 62.

The control board 58 provides electrical connections between the vibration motor 52, the electrical power source 54 and the pressure-actuated switch 56. It may also include components for regulating charging of the power source 54. As an additional feature, the control board 58 may optionally include components that allow a user to control the mode and/or intensity of the vibrations delivered by the vibration motor 52.

As previously noted, the vibration motor 52, the electrical power source 54, the pressure-actuated electrical switch 56, and the control board 58 are all disposed within the main housing 50 of the vibrator unit, which is formed in the illustrated embodiment by the lower housing section 44 and the upper housing section 46. A bottom end 68 of the main housing 50 may be fully closed by an integral bottom wall 44C of the lower housing section 44. A top end 70 of the main housing 50 may be partially closed by a cap member 72 that seats within an upper opening 46C at the top of the upper housing section 46. The cap member 72 may be formed as a disk-like member that is supported by an annular shoulder 46D recessed from the upper opening 46C.

One or more vent openings 74 (two are shown) may be formed in the cap member 56. The vent openings 74 are arranged to pass air between the upper interior compartment 50A of the vibrator unit's main housing 50 and the greater interior portion of the vacuum vessel 4 that surrounds the main housing. As previously mentioned, the vibrator unit 26 is disposed in the vacuum vessel so that the vent openings 74 are arranged proximate to the vacuum port 14 and the vent port 16 of the vacuum vessel 4.

If desired, an optional air flow conduit 76 (only one is shown) may extend a short distance below each vent opening 74 into close proximity with the actuator member 60 of the pressure-actuated switch 56. The air flow conduits 76 may help facilitate switch actuation as air flows out of and into the vent openings 74 during use of the genital therapy apparatus 2.

A pair of electrodes 78 exposed on the top surface of the cap member 72 may be connected to the control board 58 to facilitate charging of the electrical power source 54. Although not shown, charging energy may be provided by an external charging device configured to receive or otherwise accommodate the top of the main housing 50 (after the internal sleeve and vibration motor unit assembly 26/30 has been removed from the vacuum vessel 4), and to electrically engage the electrodes 78.

In order to enable access to vibration motor 52 and the power source 54 within the interior of the vibrator unit's main housing 50, the lower housing section 44 and the upper housing section 46 may be formed as discrete components that are detachably interconnected. In the illustrated embodiment, a threaded interconnection 80 is provided, with the lower housing section 44 being male threaded and the upper housing section being female threaded (or visa versa). An o-ring seal 82 is provided at the base of the threaded interconnection 80 to isolate the main housing's lower interior compartment 50B from pressure fluctuations outside the vibrator unit's main housing 50. One advantage of providing a detachable interconnection between the lower housing section 44 and the upper housing section 46 is to facilitate replacement of the vibration motor 52 and/or the power source 54. To facilitate such replacement, either or both components may be connected to the control board 58 using a detachable connector.

Returning now to FIG. 1, the genital therapy apparatus 2 may be used according to a therapeutic method now to be described. Initially, a user's genital (not shown) that is to receive combined vacuum and vibratory therapy is introduced into the suction sleeve 30 disposed within the vacuum vessel 4. The lowermost ring 48A-1 of the cuff 48 that forms the bottom of the sleeve 30 (at the vacuum vessel's lower opening 10) may be placed in sealing engagement against an adjacent body portion that surrounds the genital, or it may be brought into sealing engagement with the base of the genital itself. The vacuum pump 18 may then be operated to reduce the air pressure within the vacuum vessel 4 to initiate vacuum therapy to the genital.

When the air pressure within the vacuum vessel 4 drops to the activation threshold pressure of the vibrator unit 26, the vibrator unit's pressure-actuated switch 56 will actuate the vibration motor 52 so as to initiate vibratory therapy in addition to vacuum therapy. As previously explained, the reduced pressure will cause the switch 56 to transition from its initial open circuit condition in which the electrical power source 54 and the vibration motor 52 are electrically disconnected, to its closed circuit condition in which the electrical power source and the vibration motor are electrically interconnected and the vibration motor is energized.

When it is desired to discontinue the vibratory therapy, the vibration motor unit 52 may be deactivated by discontinuing operation of the vacuum pump and venting the vacuum vessel (e.g., using the finger-operated pressure relieve valve mechanism 20). This will result in the pressure-actuated switch 56 of the vibration motor unit 26 being allowed to transition back to its open circuit condition in which the electrical power source 54 and the vibration motor 52 are electrically disconnected. The user may then continue with vacuum therapy if below-ambient pressure remains in the vacuum vessel 4, or they may vent the vacuum vessel completely to return it to ambient pressure. In the latter case, the user may remove their genital from the sleeve 30 within the vacuum vessel 4 once ambient pressure has been restored.

Accordingly, a combined vacuum and vibratory genital massage therapy massage therapy apparatus has been disclosed. Although the massage therapy apparatus has been described and shown in the context of certain example embodiments, it should be apparent that many variations and alternative embodiments could be implemented in accordance with the present disclosure.

Reference in the present disclosure to an “embodiment” means that a particular feature, structure or characteristic described in connection with the embodiment may be included in at least one embodiment of the disclosed apparatus. Thus, the appearances of the term “embodiment” in various places throughout the specification are not necessarily all referring to the same embodiment.

For purposes of explanation, specific configurations and details have been set forth herein in order to provide a thorough understanding of the present invention. However, it will be apparent to one of ordinary skill in the art that embodiments of the present invention may be practiced without the specific details presented herein. Furthermore, well-known features may have been omitted or simplified in order not to obscure the present invention. Various examples may have been given throughout this description. These examples are merely descriptions of specific embodiments of the invention. The scope of the invention is not limited to the examples given.

As used in this application, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

It is therefore understood, in view of the foregoing, that the invention is not to be in any way limited except in accordance with the spirit of the appended claims and their equivalents.

What is claimed is:

1. A combined vacuum and vibratory genital therapy apparatus, comprising:
a vacuum vessel that is sized and configured to accommodate a human genital therein;
the vacuum vessel having an opening to receive the human genital while forming a vacuum vessel air seal that allows air pressure to be reduced within the vacuum vessel;
a vacuum pump operatively connected to the vacuum vessel and operable to remove air from the vacuum vessel in order to reduce the air pressure therein; and
a pressure-actuated vibrator unit arranged to deliver vibratory stimulation to the human genital when disposed within the vacuum vessel in response to the air pressure in the vacuum vessel being reduced to a predetermined air pressure level representing a vibrator unit activation threshold pressure.

2. The apparatus of claim 1, wherein the vacuum vessel is sized and configured to accommodate one of a male or female human genital therein.

3. The apparatus of claim 1, wherein the vibrator unit comprises an electric vibration motor, an electrical power source, and a pressure-actuated electrical switch operable to electrically connect the electrical power source to the electric vibration motor in response to the air pressure within the vacuum vessel being at or below the activation threshold pressure, and to electrically disconnect the electrical power source from the electric motor in response to the air pressure within the vacuum vessel being above the activation threshold pressure.

4. The apparatus of claim 3, wherein the vibrator unit is disposed within the vacuum vessel.

5. The apparatus of claim 4, wherein the vibrator unit comprises a vibrator unit housing in which the electrical power source, the electrical vibration motor and the pressure-actuated electrical switch are disposed.

6. The apparatus of claim 5, wherein the vibrator unit housing comprises discrete housing sections that are detachably interconnected to enable access to the electrical power source and the electrical vibration motor.

7. The apparatus of claim 5, wherein the vibrator unit housing comprises one or more vent openings arranged to pass air between an interior of the vibrator unit housing and a greater interior portion of the vacuum vessel that surrounds the vibrator unit housing.

8. The apparatus of claim 7, wherein the pressure-actuated electrical switch comprises an actuator member, a stationary electrical contact, and a throw member carrying a movable electrical contact, the actuator member being operable to undergo movement in response to air pressure fluctuations caused by air flow through the vent openings, the throw member being operatively connected to the actuator member such that the movement of the actuator member causes the throw member to move in manner that brings the movable electrical contact into and out of electrical engagement with the stationary electrical contact, thereby causing the vibration motor to correspondingly switch on and off.

9. The apparatus of claim 7, wherein the vibrator unit housing is disposed in the vacuum vessel so that the vent openings of the vibrator unit housing are arranged proximate to a vent port of the vacuum vessel that is in fluid communication with the vacuum pump.

10. The apparatus of claim 5, wherein the vibrator unit housing is removable from the vacuum vessel and comprises a pair of electrodes operable to engage an external charging device and deliver charging energy to the electrical power source.

11. The apparatus of claim 5, wherein the vibrator unit housing is mounted to an insert that is removably disposed within the vacuum vessel.

12. The apparatus of claim 11, wherein the insert comprises a flexible sleeve that extends into the vacuum vessel from the vacuum vessel opening, and is sized and configured to accommodate the human genital.

13. The apparatus of claim 12, wherein, the vibrator unit housing is attached to a first end portion of the flexible sleeve that is distal from the vacuum vessel opening.

14. The apparatus of claim 13, wherein the first end portion of the sleeve comprises a sleeve opening through which the vibrator unit housing extends, the vibrator unit housing being secured to the sleeve opening and arranged so that a first portion of the vibrator unit housing that contains the electric vibration motor is disposed within the sleeve, and a second portion of the vibrator housing that contains the pressure-actuated electrical switch is disposed outside the sleeve.

15. The apparatus of claim 14, wherein one or more air vent passages are provided to allow air to flow around the vibrator unit housing from outside the sleeve to inside the sleeve, and visa versa.

16. The apparatus of claim 15, wherein the one or more air vent passages are provided by a collar that mounts the vibrator unit housing to the sleeve opening.

17. The apparatus of claim 12, wherein the vibrator unit housing is detachably mounted to the sleeve to enable cleaning of the sleeve with the vibrator unit separated therefrom, or to enable servicing, repairing or replacing the vibrator unit 26 with the sleeve separated therefrom.

18. The apparatus of claim 13, wherein a foldable second end portion of the sleeve is flipped inside out to wrap around the vacuum vessel opening to form a cuff comprising plural gripping rings, a lower one of which surrounds the vacuum vessel opening to act as a resilient seal member that enhances the vacuum vessel air seal.

19. A method of using the apparatus of claim 1, comprising:
inserting the human genital inside the vacuum vessel and sealing the vacuum vessel opening against a base of the human genital or an adjacent pubic area that surrounds the human genital;
operating the vacuum pump to reduce the air pressure within the vacuum vessel until the vibration motor unit is activated to deliver vibratory stimulation to the human genital in response to the air pressure within the vacuum vessel being reduced to the activation threshold pressure;
subsequently deactivating the vibration motor unit by venting the vacuum vessel; and
removing the human genital from the vacuum vessel.

20. A combined vacuum and vibratory genital therapy apparatus, comprising:
a vacuum vessel that is sized and configured to accommodate a human genital therein;
the vacuum vessel having an opening to receive the human genital while forming an air seal that allows air pressure to be reduced within the vacuum vessel;
a vacuum pump operatively connected to the vacuum vessel and operable to remove air from the vacuum vessel in order to reduce the air pressure therein;
a pressure-actuated vibrator unit arranged to deliver vibratory stimulation to the human genital when disposed within the vacuum vessel in response to the air pressure in the vacuum vessel being reduced to a predetermined air pressure level representing a vibrator unit activation threshold pressure;
the vibrator unit comprising an electric vibration motor, an electrical power source, and a pressure-actuated electrical switch operable to electrically connect the electrical power source to the electric motor in response to the air pressure within the vacuum vessel being at or below the predetermined air pressure level, and to electrically disconnect the electrical power source from the electric motor in response to the air pressure within the vacuum vessel being above the predetermined air pressure level;
the vibrator unit being disposed within the vacuum vessel;
the vibrator unit comprising a vibrator unit housing in which the electrical power source, the electrical vibration motor and the pressure-actuated electrical switch are disposed;
the vibrator unit housing comprising one or more vent openings arranged to pass air between an interior of the vibrator unit housing and a greater interior portion of the vacuum vessel;
the vibrator unit being mounted to an insert that is removably disposed within the vacuum vessel;
the insert comprising a flexible sleeve that extends into the vacuum vessel from the opening thereof and is sized and configured to accommodate the human genital;
the flexible sleeve comprising a first end portion distal from the vacuum vessel opening to which the vibrator unit housing is attached;
the first end portion of the flexible sleeve comprising an opening through which the vibrator unit housing extends, the vibrator unit housing being secured to the flexible sleeve opening and arranged so that a first portion of the vibrator unit housing that contains the electric vibration motor is disposed within the flexible sleeve and a second portion of the vibrator housing that contains the pressure-actuated electrical switch is disposed outside the flexible sleeve;
the flexible sleeve comprising a foldable second end portion that is flipped inside out to wrap around the vacuum vessel opening and form a resilient cuff; and
the flexible sleeve being removable from the vacuum vessel and the vibrator unit being removable from the flexible sleeve.
